(19) United States
(12) Patent Application Publication
(10) Pub. No.: US 2009/0003335 A1
(43) Pub. Date: Jan. 1, 2009

(54) Device, System and Method of Fragmentation of PCI Express Packets

(75) Inventors: Giora Biran, Zichron Yaacov (IL); Ilya Granovsky, Haifa (IL); Elchanan Perlin, Haifa (IL)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 11/771,279

(22) Filed: Jun. 29, 2007

(51) Int. Cl. H04L 12/56

(52) U.S. Cl. 370/389

(57) ABSTRACT

Device, system and method of fragmentation of PCI Express packets. For example, an apparatus includes a credit-based flow control interconnect device to fragment a Transaction Layer Packet into a stream of micro-packets, wherein the stream comprises an initial micro-packet and one or more continuation micro-packets.

### FIELD OF THE INVENTION

Some embodiments of the invention are related to the field of communication using Peripheral Component Interconnect (PCI) Express (PCIe).

### BACKGROUND OF THE INVENTION

A computer system may include a PCI Express (PCIe) host bridge able to connect between, for example, a processor and other units, e.g., a graphics card, a memory unit, or the like. PCIe is an input/output (I/O) protocol allowing transfer of packetized data over high-speed serial interconnects with flow control-based link management. PCIe specifies a Maximum Payload Size (MPS) parameter for various units. The MPS parameter indicates the maximum packet's data payload size allowed on the link.

Unfortunately, utilization of a large payload or a small payload may result in various disadvantages. For example, a large payload may improve link utilization, but increases overall latency, requires larger receiver buffers, and results in decreased utilization of buffering resources (e.g., due to a long flow control update cycle). A small payload may introduce significant link overhead, e.g., up to approximately 30 percent of the available bandwidth.

### SUMMARY OF THE INVENTION

Some embodiments of the invention include, for example, devices, systems and methods of fragmentation of PCI Express (PCIe) packets.

Some embodiments include, for example, an apparatus including a credit-based flow control interconnect device to fragment a Transaction Layer Packet into a stream of micro-packets, and the stream includes an initial micro-packet and one or more continuation micro-packets.

In some embodiments, the initial micro-packet includes an initial header, each continuation micro-packet includes a continuation header, and the size of the continuation header is smaller than the size of the initial header.

In some embodiments, continuation headers of substantially all the continuation micro-packets have the same size.

In some embodiments, the size of substantially each continuation header is not larger than one Double Word.

In some embodiments, the initial header includes an indication that one or more continuation micro-packets are expected to follow the initial micro-packet.

In some embodiments, the indication in the initial header is encoded in at least one of: a Format field of the initial header, and a Type field of the initial header.

In some embodiments, the initial header includes an indication of the number of micro-packets in the stream.

In some embodiments, substantially each continuation header includes a micro-packet sequence identification number and a micro-packet packet number.

In some embodiments, the apparatus further includes another credit-based flow control interconnect device to receive the stream of micro-packets and to re-assemble the Transaction Layer Packet from the stream of micro-packets.

In some embodiments, the credit-based flow control interconnect device includes a PCI Express device.

In some embodiments, a method includes, for example, dividing a Transaction Layer Packet of a credit-based flow control interconnect protocol into a stream of fragments, wherein the stream includes an initial fragment and one or more continuation fragments.

In some embodiments, the method includes transferring the stream of fragments over a link layer of the credit-based flow control interconnect protocol.

In some embodiments, the method includes receiving the stream of fragments; and re-assembling the Transaction Layer Packet from the stream of fragments.

In some embodiments, the credit-based flow control interconnect protocol includes PCI Express, and the method includes: checking whether or not a PCI Express device supports PCI Express packet fragmentation; and if the PCI Express device supports PCI Express packet fragmentation, transferring to the PCI Express device the stream of fragments.

In some embodiments, the credit-based flow control interconnect protocol includes PCI Express, and the method includes: checking whether or not a PCI Express device supports PCI Express packet fragmentation; and if the PCI Express device does not support PCI Express packet fragmentation, transferring to the PCI Express the PCI Express Transaction Layer Packet.

In some embodiments, the credit-based flow control interconnect protocol includes PCI Express, and dividing a PCI Express Transaction Layer Packet into a stream of fragments includes dividing a PCI Express request Transaction Layer Packet into a stream of fragments.

In some embodiments, the credit-based flow control interconnect protocol includes PCI Express, and dividing a PCI Express Transaction Layer Packet into a stream of fragments includes dividing a PCI Express completion Transaction Layer Packet into a stream of fragments.

In some embodiments, a system includes a credit-based flow control interconnect device to fragment a credit-based flow control interconnect Transaction Layer Packet into a stream of micro-packets, wherein the stream includes an initial micro-packet and one or more continuation micro-packets; and a credit-based flow control interconnect link layer to transfer the stream of micro-packets.

In some embodiments, the system further includes at least one additional credit-based flow control interconnect device to receive the stream of micro-packets and to re-assemble the Transaction Layer Packet from the stream of micro-packets.

In some embodiments, the credit-based flow control interconnect device includes a PCI Express device, the initial micro-packet includes an initial header, each continuation micro-packet includes a continuation header, and the size of the continuation header is smaller than the size of the initial header.

Some embodiments may include, for example, a computer program product including a computer-useable medium including a computer-readable program, wherein the computer-readable program when executed on a computer causes the computer to perform methods in accordance with some embodiments of the invention.

Some embodiments of the invention may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system able to utilize PCIe packets fragmentation and re-assembly in accordance with a demonstrative embodiment of the invention;

FIGS. 2A to 2E are schematic block diagram illustrations of structure of micro-packet headers in accordance with a demonstrative embodiment of the invention; and

FIG. 3 is a schematic flow-chart of a method of PCI Express packet fragmentation and re-assembly in accordance with a demonstrative embodiment of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein may include, for example, “multiple” or “two or more”. For example, “a plurality of items” includes two or more items.

Although portions of the discussion herein may relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments of the invention may utilize wired communication and/or wireless communication.

The terms “micro-packet” or “micropacket” or “u-packet” or “packet fragment” or “fragment” as used herein may include, for example, a fragment of a PCIe packet (e.g., created by fragmentation of a TLP into fragments), a PCIe packet-fragment having a reduced-size header, and/or a PCIe packet-fragment having a non-conventional header or a modified header in accordance with some embodiments of the invention.

The terms “micro-packet stream” or “macro-packet” or “macropacket” as used herein may include, for example, a series, a sequence, a set, a group or a stream of micro-packets (e.g., consecutive or non-consecutive) which are part of a single or common data transfer, and/or referencing a common full header, and/or corresponding to a single or common PCIe TLP.

The terms “first fragment” or “first micro-packet” or “initial fragment” or “initial micro-packet” as used herein may include, for example, a first or initial micro-packet of a micro-packet stream.

The terms “continuation micro-packet” or “continuation fragment” or “non-first micro-packet” or “non-first fragment” or “non-initial micro-packet” or “non-initial fragment” or “subsequent micro-packet” or “subsequent fragment” as used herein may include, for example, a non-initial micro-packet that follows (e.g., consecutively or non-consecutively) the initial micro-packet.

The term “initial header” as used herein may include, for example, a header of an initial micro-packet.

The term “continuation header” as used herein may include, for example, a header of a continuation micro-packet.

The term “micro-packet header” as used herein may include, for example, an initial header and/or a continuation header.

The terms “Double Word” or “DWord” or “DW” as used herein may include, for example, a data unit having a size of four bytes.

The terms “Maximum Payload Size” or “MPS” as used herein may include, for example, a PCIe parameter indicating the maximum size of data payload in a packet.

The terms “sending device” or “sending endpoint” or “sending port” as used herein may include, for example, a PCIe device, a PCIe endpoint, a PCIe port, or other PCIe unit or PCIe-compatible unit able to send or transfer-out PCIe data.

The terms “receiving device” or “receiving endpoint” or “receiving port” as used herein may include, for example, a PCIe device, a PCIe endpoint, a PCIe port, or other PCIe unit or PCIe-compatible unit able to receive or transfer-in PCIe data.

Although portions of the discussion herein relate, for demonstrative purposes, to PCIe communications or devices, embodiments of the invention may be used with other types of communications or devices, for example, communications or devices utilizing transfer of packetized data over high-speed serial interconnects, communications or devices utilizing flow control-based link management, communications or devices utilizing credit-based flow control, communications or devices utilizing a fully-serial interface, communications or devices utilizing a split-transaction protocol implemented with attributed packets, communications or devices that prioritize packets for improved or optimal packet transfer, communications or devices utilizing scalable links having one or more lanes (e.g., point-to-point connections), communications or devices utilizing a high-speed serial interconnect, communications or devices utilizing differentiation of different traffic types, communications or devices utilizing a highly reliable data transfer mechanism (e.g., using sequence numbers and/or End-to-end Cyclic Redundancy Check (ECRC)), communications or devices utilizing a link layer to achieve integrity of transferred data, communications or devices utilizing a physical layer of two low-voltage differentially driven pairs of signals (e.g., a transmit pair and a receive pair), communications or devices utilizing link initialization including negotiation of lane widths and frequency of operation, communications or devices allowing to transmit a data packet only when it is known that a receiving buffer is available to receive the packet at the receiving side, communications or devices utilizing request packets and/or response packets, communications or devices utilizing Message Space and/or Message Signaled Interrupt (MSI) and/or in-band messages, communications or devices utilizing a software layer configuration space, communications or devices utilizing a Maximum Payload Size (MPS) parameter, or the like.

At an overview, some embodiments of the invention provide a modified PCIe protocol to allow fragmentation of large PCIe packets into smaller link-layer packets, which are referred to as micro-packets or fragments. A large Transaction Layer Packet (TLP) (“macro-packet”) sent by a sending device to a receiving device is fragmented into multiple micro-packets, which are transferred over the link layer as a stream of micro-packets, and are re-assembled (e.g., upon or prior to reaching the receiving device) into a substantially identical macro-packet. Some embodiments thus provide flexibility of link traffic management, as well as link utilization advantages associated with a large payload.

In some embodiments, the modified PCIe protocol specifies large TLPs fragmentation by the link layer into smaller link packets (namely, micro-packets) having a reduced-size micro-packet header, e.g., a one-DW continuation header. In some embodiments, the size of an initial header is similar or substantially identical to the size of a conventional PCIe packet header; whereas the size of a continuation header is smaller than the size of a conventional PCIe packet header. In some embodiments, the amount of information included in the continuation header is smaller or significantly smaller than the amount of information included in a conventional PCIe packet header. For example, in some embodiments, the continuation header includes substantially only a Traffic Class (TC) and type attributes of the micro-packet, and further includes indication(s) to maintain and/or validate correct micro-packets count and/or ordering.

Some embodiments provide a modified PCIe protocol, which defines and supports PCIe packet fragmentation into micro-packets and re-assembly of micro-packets. The modified PCIe protocol is implemented using the PCIe Capability Structure, namely, the PCIe Capability register set. For example, configuration space bits in the Link Capabilities Register and/or in the Link Control Register are used to advertise or notify that a sending device and/or a receiving device and/or a PCIe component or link requests or supports PCIe packet fragmentation, as well as to provide control and configuration fields for implementing the fragmentation into micro-packets or the re-assembly of micro-packets into a macro-packet.

Some embodiments may require that the sending device, the receiving device and/or PCIe links between them (e.g., a PCIe host, a PCIe switch, or the like) support PCIe packet fragmentation in accordance with the modified PCIe protocol. When PCIe packet fragmentation is enabled, the sending device (or another unit or port on its behalf) is allowed to split or divide or “slice” a large TLP (or multiple large TLPs) into smaller link packets, namely, micro-packets. In some embodiments, PCIe packet fragmentation is allowed only across 128-byte address boundaries.

The initial micro-packet in a stream of micro-packets includes an initial header which may be similar to a conventional PCIe packet header (e.g., request or completion), having substantially all the parameters of a conventional header (e.g., length, size, etc.), but being partially modified to reflect that it is an initial header of a stream of micro-packets. A pre-defined field of the initial header (e.g., optionally, a reserved field) indicates that the PCIe packet is fragmented, namely, that a large PCIe TLP is fragmented into a stream of micro-packets which includes the current first micro-packet and one or more continuation micro-packets. The continuation micro-packets specify a pre-defined type, indicating that the actual header size of each continuation header is a reduced-size, e.g., one Double Word.

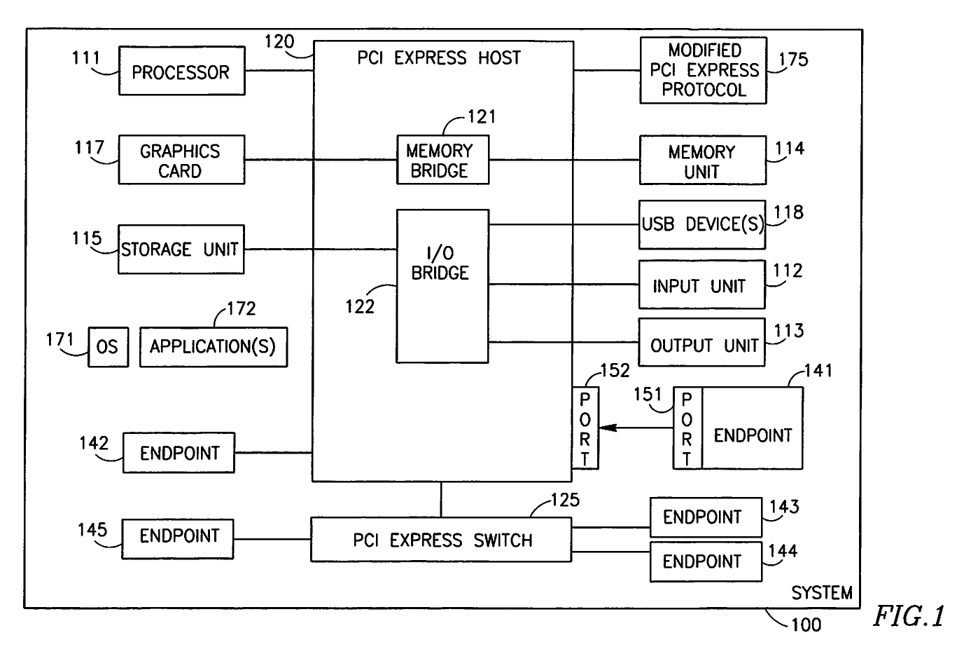

FIG. 1 schematically illustrates a block diagram of a system 100 able to utilize PCIe packets fragmentation and re-assembly in accordance with some demonstrative embodiments of the invention. System 100 may be or may include, for example, a computing device, a computer, a personal computer (PC), a server computer, a client/server system, a mobile computer, a portable computer, a laptop computer, a notebook computer, a tablet computer, a network of multiple inter-connected devices, or the like.

System 100 may include, for example, a processor 111, an input unit 112, an output unit 113, a memory unit 114, a storage unit 115, a communication unit 116, and a graphics card 117. System 100 may optionally include other suitable hardware components and/or software components.

Processor 111 may include, for example, a Central Processing Unit (CPU), a Digital Signal Processor (DSP), a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 111 may execute instructions, for example, of an Operating System (OS) 171 of system 100 or of one or more software applications 172.

Input unit 112 may include, for example, a keyboard, a keypad, a mouse, a touch-pad, a stylus, a microphone, or other suitable pointing device or input device. Output unit 113 may include, for example, a cathode ray tube (CRT) monitor or display unit, a liquid crystal display (LCD) monitor or display unit, a screen, a monitor, a speaker, or other suitable display unit or output device. Graphics card 117 may include, for example, a graphics or video processor, adapter, controller or accelerator.

Memory unit 114 may include, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units. Storage unit 115 may include, for example, a hard disk drive, a floppy disk drive, a compact disk (CD) drive, a CD-ROM drive, a digital versatile disk (DVD) drive, or other suitable removable or non-removable storage units. Memory unit 114 and/or storage unit 115 may, for example, store data processed by system 100.

Communication unit 116 may include, for example, a wired or wireless network interface card (NIC), a wired or wireless modem, a wired or wireless receiver and/or transmitter, a wired or wireless transmitter-receiver and/or transceiver, a radio frequency (RF) communication unit or transceiver, or other units able to transmit and/or receive signals, blocks, frames, transmission streams, packets, messages and/or data. Communication unit 116 may optionally include, or may optionally be associated with, for example, one or more antennas, e.g., a dipole antenna, a monopole antenna, an omni-directional antenna, an end fed antenna, a circularly polarized antenna, a micro-strip antenna, a diversity antenna, or the like.

In some embodiments, the components of system 100 may be enclosed in, for example, a common housing, packaging, or the like, and may be interconnected or operably associated using one or more wired or wireless links. In other embodiments, for example, components of system 100 may be distributed among multiple or separate devices, may be implemented using a client/server configuration or system, may communicate using remote access methods, or the like.

System 100 may further include a PCIe host bridge 120 able to connect among multiple components of system 100, e.g., among multiple PCIe endpoints or PCIe devices. The PCIe host bridge 120 may include a memory bridge 121 or other memory controller, to which the memory unit 114 and/or the graphics card 117 may be connected. The PCIe host bridge 120 may further include an Input/Output (I/O) bridge 122, to which the input unit 112, the output unit 113, the storage unit 115, the communication unit 116, and one or more Universal Serial Bus (USB) devices 118 may be connected.

System 100 may further include a PCIe switch 125 able to interconnect among multiple PCIe endpoints or PCIe devices. In some embodiments, the PCIe switch 125 may be implemented as a separate or stand-alone unit or component; in other embodiments, the PCIe switch 125 may be integrated in, embedded with, or otherwise implemented using the PCIe host bridge 120 or other suitable component.

The topology or architecture of FIG. 1 are shown for demonstrative purposes, and embodiments of the invention may be used in conjunction with other suitable topologies or architectures. For example, in some embodiments, memory bridge 121 is implemented as a memory controller and is included or embedded in the PCIe host bridge 120. In some embodiments, a “north bridge” or a “south bridge” are used, and optionally include the PCIe host bridge 120 and/or a similar PCIe host component. In some embodiments, memory bridge 121 and PCIe host bridge 120 (and optionally the processor 111) are implemented using a single or common Integrated Circuit (IC), or using multiple ICs. Other suitable topologies or architectures may be used.

The PCIe host bridge 120 and/or the PCIe switch 125 may interconnect among multiple PCIe endpoints or PCIe devices, for example, endpoints 141-145. For demonstrative purposes, endpoint 141 may send data to the memory bridge 121; accordingly, endpoint 141 is referred to herein as “sending endpoint” or “sending device”, whereas the memory bridge 121 is referred to herein as “receiving endpoint” or “receiving device”. Other components may operate as a sending device and/or as a receiving device. For example, processor 111 may be a sending device and memory unit 114 may be a receiving device; USB device 118 may be a sending device and storage unit 115 may be a receiving device; the memory bridge 121 may operate as a receiving device (e.g., vis-à-vis a first endpoint or component) and/or may operate as a sending device (e.g., vis-à-vis a second endpoint or component); or the like. In some embodiments, the receiving device may send back data or control data to the sending device, or vice versa; for example, the communication between the sending device and the receiving device may be unilateral or bilateral.

Optionally, the sending device may operate utilizing a device driver, and the receiving device may operate utilizing a device driver. In some embodiments, the device drivers, as well as PCIe host bridge 120 and PCIe switch 125, may support a modified PCIe protocol 175 in accordance with some embodiments of the invention.

In some embodiments, the sending device transfers data to the receiving device using the modified PCIe protocol 175, namely, using fragmentation of PCIe packet(s) into micro-packets and re-assembly of micro-packets into PCIe packet(s). For example, the sending device sends data, which is fragmented into multiple micro-packets 190 by a PCIe port 151 on the sending device. The micro-packets 190 are transferred as a stream on the link layer. The received micro-packets 190 are re-assembled or merged or spliced, for example, by a PCIe port 152 on the receiving device side into data. The re-assembled data received by the receiving device is substantially identical to the original data sent by the sending device.

In some embodiments, the header of the first micro-packet (namely, the initial header) in the stream of micro-packets is different from the headers of subsequent micro-packets in that stream. The initial header may use a modified PCIe packet header, for example, including a pre-defined value in the Format (Fmt) field and/or a pre-defined value in the Type field, to indicate that the current micro-packet is an initial micro-packet in a stream of micro-packets, and that one or more continuation micro-packets are expected to follow the current initial micro-packet. For example, the Length field of the initial header is modified or re-defined to include a micro-packet sequence ID (e.g., occupying five bits) and a micro-packet packet number (e.g., occupying five bits).

Each one of the subsequent micro-packets (namely, the continuation micro-packets) of the stream of micro-packets includes a continuation header. The continuation header has a reduced size, namely, a size smaller than the size of a conventional PCIe packet header, and/or a size smaller than the size of the initial header of the initial micro-packet. For example, a continuation header (of a continuation micro-packet) occupies one Double Word, and includes: a micro-packet header indication (e.g., using a pre-defined value in the Format (Fmt) field and/or in the Type field); a micro-packet sequence ID (e.g., occupying five bits); a micro-packet packet number (e.g., occupying five bits); Traffic Class (TC) information (e.g., occupying three bits); an Error Parity or “Error Poisoned” (EP) field (e.g., occupying one bit); and a TLP Digest (TD) field (e.g., occupying one bit). In some embodiments, continuation headers of continuation micro-packets do not consume header credits. In some embodiments, continuation headers of continuation micro-packets are not covered by a End-to-end Cyclic Redundancy Check (ECRC) mechanism.

In some embodiments, the micro-packet sequence ID field of a micro-packet header (namely, of an initial header and/or a continuation header) occupies five bits, and uniquely associates between a micro-packet of a stream and the initial header of that stream. For example, the headers of substantially all the micro-packets of a single transaction (e.g., including the initial micro-packet in the stream, the last micro-packet in the stream, and other micro-packets between the first and the last micro-packets of the stream) have the same value in the micro-packet sequence ID field.

In some embodiments, the micro-packet packet number field of a micro-packet header (namely, of an initial header and/or a continuation header) occupies five bits. In the initial header of the initial micro-packet in a stream, the value of the micro-packet packet number field is equal to the total number of micro-packets in the stream. In continuation headers of continuation micro-packets, the value of the micro-packet packet number field is decremented at each successive micro-packet. In some embodiments, for example, the value of the micro-packet packet number field of the header of the last fragment in the stream is “00000”.

In some PCIe endpoint(s) or device(s). The payload size information indicates one or more supported payload sizes, and the configuration space allows to select a unique payload size (e.g., a particular size, and not a range of sizes) from the group of supported payload sizes. Optionally, a set of pre-defined values are use to specify capability options (namely, supported payload sizes), for example, a pre-defined set including supported payload sizes of 16 bytes, 32 bytes, 64 bytes, 128 bytes, and 256 bytes. Substantially all the micro-packets of a single transaction (e.g., including the initial micro-packet in the stream, the last micro-packet in the stream, and other micro-packets between the first and the last micro-packets) have the same payload size. In some embodiments, a constant payload size of micro-packets is a particular implementation of a flexible payload size of micro-packet (discussed herein), wherein the sending device disconnects at substantially every address boundary.

In other embodiments, a flexible or variable payload size of micro-packets is used, such that micro-packets associated with the same transaction may have different payload sizes. For example, a micro-packet is able to disconnect at pre-defined address boundaries; length check is disabled at the micro-packet level, and performed at the stream (macro-packet) level; and the micro-packet packet number is included only in the initial header (of the initial micro-packet in the stream) and indicates the total length of the stream. In some embodiments, micro-packet size is subject to the available data credits. In some embodiments, pause and resume mechanisms may be used in conjunction with micro-packets, and no link layer changes are required.

In some embodiments, micro-packet are handled by the PCIe data link layer similarly to the way in which conventional PCIe TLPs are handled. If a Negative-Acknowledgment Character (“NAK”) or another (e.g., non-character) negative acknowledgement is encountered or required, the data link layer handles (e.g., substantially automatically) replay of the relevant micro-packet(s), or otherwise communicates the negative acknowledgment using a Data Link Layer Packet (DLLP). The data link layer preserves micro-packets order, thereby avoiding stream interruptions due to replay.

In some embodiments, a stream of micro-packet (e.g., corresponding to a single transaction or a single macro-packet) consumes a single header credit. Header credit is released after completion of processing of the entire stream of micro-packets. The stream ID is unique per link, and identifies the stream header processing resource at the receiving device. The stream ID may change, for example, when the stream passes through the PCIe switch 125.

In some embodiments, the PCIe switch 125 may be allowed to assemble a stream of micro-packets into a single large packet (macro-packet); this may be performed, for example, if the E-CRC mechanism is disabled or covers the entire macro-packet. Similarly, the PCIe switch 125 may be allowed to fragment or divide a large packet (macro-packet) into micro-packets; this may be performed, for example, if the E-CRC mechanism is disabled or covers the entire macro-packet.

In some embodiments, the stream ID of a stream of micro-packets is managed on each link, and not end-to-end. For example, an ingress port of the PCIe switch 125 may receive a stream having a first value of stream ID, and the egress port of the PCIe switch 125 may modify the value of the stream ID to a second, different, value. In some embodiments, the PCIe switch 125 may be allowed to interleave different streams of micro-packets at the egress port. In some embodiments, routing information of a stream of micro-packets is captured in the ingress port of the PCIe switch 125, and applied to substantially all the micro-packets of that stream.

Some embodiments may use a mechanism or pre-defined scheme to ensure that a micro-packet is identified by the receiving device as a micro-packet in accordance with the modified PCIe protocol 175, and not as a malformed PCIe packet. For example, micro-packet size is determined (e.g., substantially exclusively) using configuration registers, fragmentation is performed across aligned address boundaries, and thus the provided initial request address micro-packets may be calculated by the receiving device. In some embodiments, a field or bit in the micro-packet header indicates that the TLP is fragmented in accordance with the modified PCIe protocol 175, and/or that conventional PCIe packet length calculation is not applicable for the stream of micro-packet; accordingly, the receiving device is able to avoid reporting a malformed TLP error for the first micro-packet that uses such header. In some embodiments, substantially each one of the endpoints or devices may be required to indicate (e.g., through configuration space) whether or not it supports PCIe packet fragmentation; and only if the PCIe host bridge 120 and substantially all the PCIe switch(es) 125 in system 100, as well as the relevant endpoints or devices, support PCIe packet fragmentation, then packet fragmentation is enabled with regard to communication between the relevant endpoints or devices, thereby ensuring that an endpoint or device which does not support PCIe packet fragmentation does not incorrectly report a malformed PCIe packet error. Other suitable mechanisms or schemes may be used to ensure backward compatibility of the modified PCIe protocol 175 or to reduce reporting of “false negative” errors.

In some embodiments, PCIe packet fragmentation may support various types of TLPs having large payloads, e.g., Memory Write (MemWr) transactions. In some embodiments, PCIe packet fragmentation may reduce read requests overhead, for example, by requiring less requests for a larger size of data. In some embodiments, PCIe packet fragmentation may support large MPS values, e.g., up to 4 kilobytes; in other embodiments, PCIe packet fragmentation may not support and may not utilize 4-kilobyte micro-packets.

In some embodiments, the configuration space of a PCIe endpoint or device is updated, modified or augmented to allow representations related to PCIe packet fragmentation capabilities of that endpoint or device. For example, some embodiments may utilize a “TLP fragmentation capable bit” in the Device Capabilities 2 register in the PCIe Capability Structure (e.g., a Read Only (RO) bit at a pre-defined location); a “TLP fragmentation enable bit” in the Device Control 2 register in the PCIe Capability Structure (e.g., a Read/Write (RW) bit at a pre-defined location); and/or a “fragment size field” in the Device Control 2 register in the PCIe Capability Structure (e.g., three bits using the PCIe size encoding, for example, from 128 bytes to 2 kilobytes, as a Read/Write (RW) field at a pre-defined location).

Some embodiments may provide performance improvement, for example, by utilizing a one Double Word ECRC covering all the micro-packets of a stream and attached to the last micro-packet of the stream.

In some embodiments, a common link or channel (e.g., a single full-duplex link or channel), or a single link or channel (or multiple, substantially identical, links or channels having common characteristics) are used to transfer the initial header of the initial micro-packet in the stream, the initial micro-packet itself, the continuation headers of continuation micro-packets, and the continuation micro-packets themselves. For example, some embodiments do not utilize a main link or a primary link (e.g., unidirectional) for one type of micro-packets or headers, and an auxiliary link or secondary link (e.g., bidirectional) for another type of micro-packet or headers. For example, some embodiments do not utilize “virtual links” or a “virtual bandwidth” associated with specific transferred micro-packets or header.

In some embodiments, PCIe packet fragmentation is performed without (or not necessarily in response to) a particular request to perform or to initiate PCIe packet fragmentation. For example, automatically upon determination that PCIe packet fragmentation is supported and/or enabled by a sending device, by a receiving device, and/or by the PCIe components (e.g., host and/or switch(es)) that inter-connect them, PCIe packet fragmentation may be performed. In some embodiments, PCIe packet fragmentation need not be triggered or initiated by (or need not depend on) a query from the sending device to the receiving device; PCIe packet fragmentation need not be triggered or initiated by (or need not depend on) a request from the receiving device and PCIe packet fragmentation need not be triggered or initiated by (or need not depend on) a particular ad-hoc determination that packet fragmentation is efficient for a particular transmission or data item or for a particular type or class of transmissions or data items.

In some embodiments, the following fields or control items are included in an initial header of an initial micro-packet, but are not included in continuation headers of continuation micro-packets: an address field (e.g., occupying 4 bytes or 8 bytes); a transaction ID field (e.g., occupying 3 bytes); a Bytes Enabled (BE) field (e.g., First-BE/Last-BE, occupying one byte); and attributes (e.g., a “Relaxed Ordering” attribute occupying one bit, a “No Snoop” attribute occupying one bit).

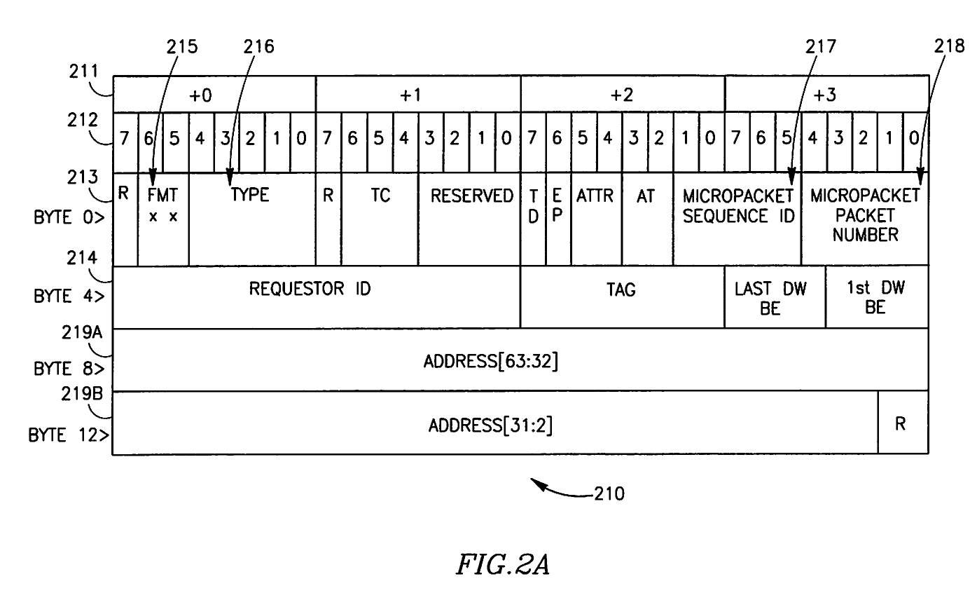

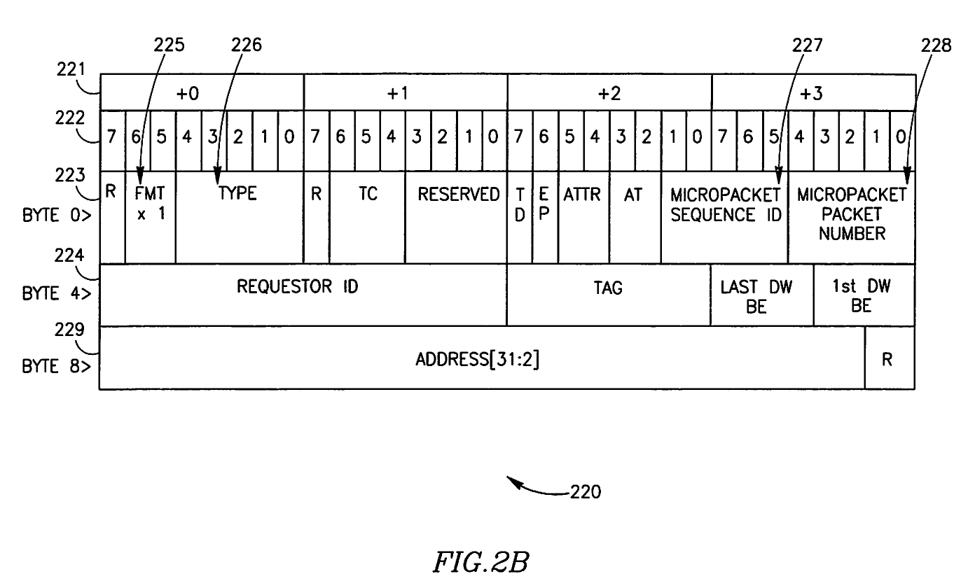

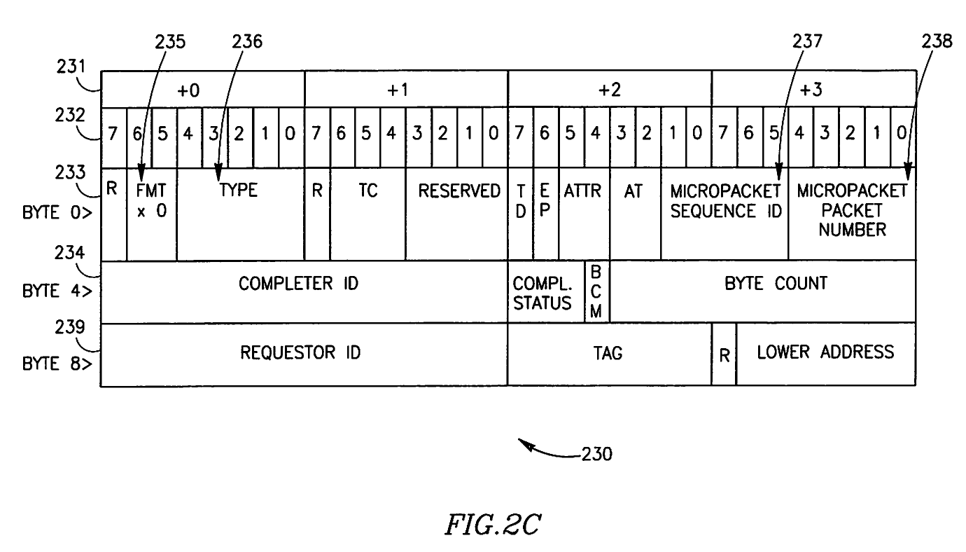

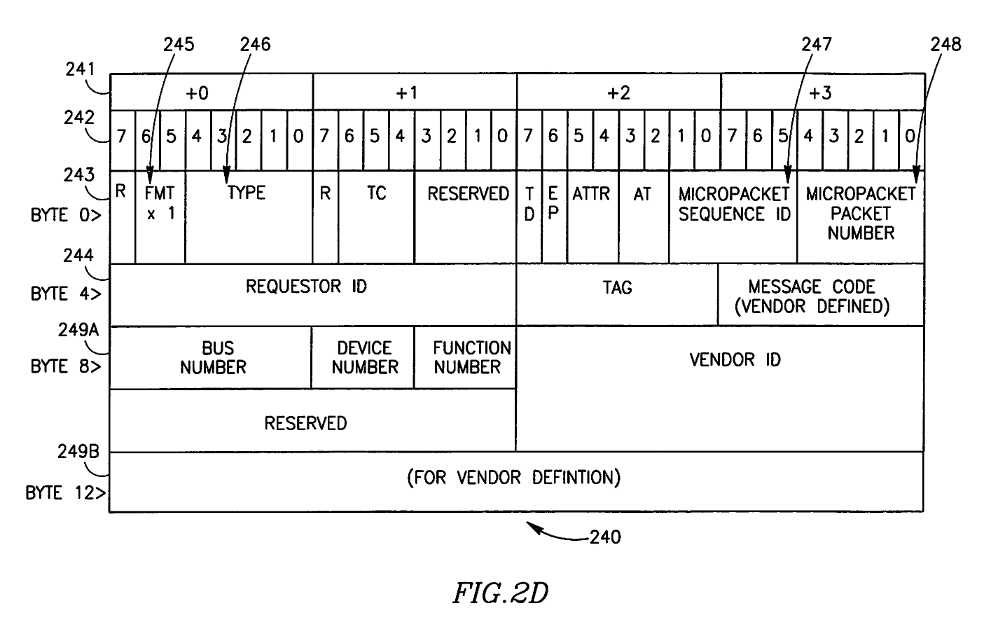

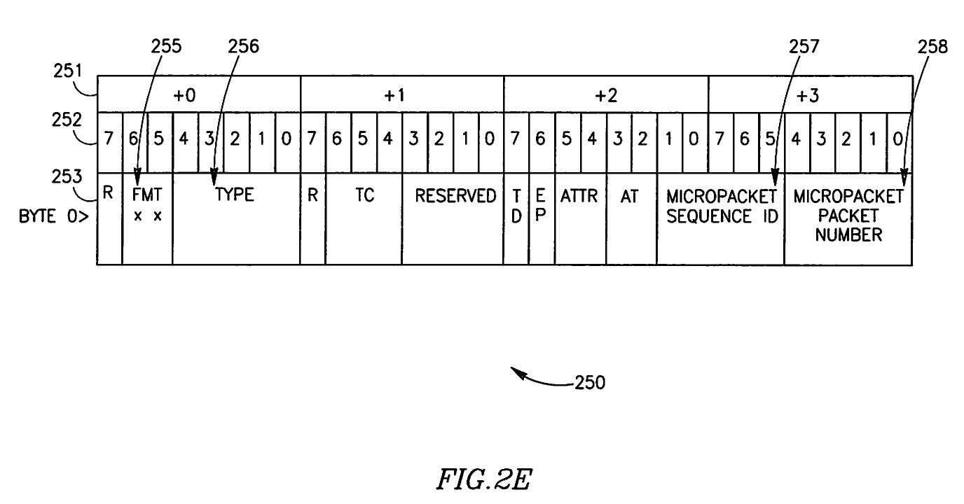

FIGS. 2A to 2E schematically illustrate structure of micro-packet headers in accordance with some demonstrative embodiments of the invention.

Reference is made to FIG. 2A, which schematically illustrate a structure of an initial micro-packet header 210 (namely, a header of an initial micro-packet in a stream) in accordance with some demonstrative embodiments of the invention. Header 210 is a header of a four Double Word request micro-packet; a first row 211 indicates the byte offset (for example, +0, +1, +2 and +3); and a second row 212 indicates the bit count (for example, eight bits numbered from 0 to 7). Header 210 includes fields of control information occupying eights bytes, as indicated in rows 213 and 214. The values in a Format (Fmt) field 215 (e.g., occupying two bits) and/or a Type field 216 (e.g., occupying five bits) are used for encoding or indicating that header 210 is a header of a four Double Word request micro-packet. As indicated at row 213, a micro-packet sequence ID field 217 (e.g., occupying five bits) and/or a micro-packet packet number field 218 (e.g., occupying five bits) are used, for example, thereby redefining or replacing a Length field. Rows 219A and 219B include a request address, for example, a 64-bit request address having two reserved lower bits.

Reference is made to FIG. 2B, which schematically illustrate a structure of an initial micro-packet header 220 (namely, a header of an initial micro-packet in a stream) in accordance with some demonstrative embodiments of the invention. Header 220 is a header of a three Double Word request micro-packet; a first row 221 indicates the byte offset (for example, +0, +1, +2 and +3); and a second row 222 indicates the bit count (for example, eight bits numbered from 0 to 7). Header 220 includes fields of control information occupying eights bytes, as indicated in rows 223 and 224. The values in a Format (Fmt) field 225 (e.g., occupying two bits) and/or a Type field 226 (e.g., occupying five bits) are used for encoding or indicating that header 220 is a header of a three Double Word request micro-packet. As indicated at row 223, a micro-packet sequence ID field 227 (e.g., occupying five bits) and/or a micro-packet packet number field 228 (e.g., occupying five bits) are used, for example, thereby redefining or replacing a Length field. Row 229 includes a request address, for example, a 32-bit request address having two reserved lower bits.

Reference is made to FIG. 2C, which schematically illustrate a structure of an initial micro-packet header 230 (namely, a header of an initial micro-packet in a stream) in accordance with some demonstrative embodiments of the invention. Header 230 is a header of a completion micro-packet; a first row 231 indicates the byte offset (for example, +0, +1, +2 and +3); and a second row 232 indicates the bit count (for example, eight bits numbered from 0 to 7). Header 230 includes fields of control information occupying eights bytes, as indicated in rows 233 and 234. The values in a Format (Fmt) field 235 (e.g., occupying two bits) and/or a Type field 236 (e.g., occupying five bits) are used for encoding or indicating that header 230 is a header of a completion micro-packet. As indicated at row 233, a micro-packet sequence ID field 237 (e.g., occupying five bits) and/or a micro-packet packet number field 238 (e.g., occupying five bits) are used, for example, thereby redefining or replacing a Length field. Row 239 includes transaction ID information, for example, a Requester ID field (e.g., occupying two bytes), a Tag field (e.g., occupying one byte), a reserved field (e.g., occupying one bit), and a lower address field (e.g., occupying seven bits copied from the original request).

Reference is made to FIG. 2D, which schematically illustrate a structure of an initial micro-packet header 240 (namely, a header of an initial micro-packet in a stream) in accordance with some demonstrative embodiments of the invention. Header 240 is a header of a Vendor-Defined Message (VDM) request micro-packet; a first row 241 indicates the byte offset (for example, +0, +1, +2 and +3); and a second row 242 indicates the bit count (for example, eight bits numbered from 0 to 7). Header 240 includes fields of control information occupying eights bytes, as indicated in rows 243 and 244. The values in a Format (Fmt) field 245 (e.g., occupying two bits) and/or a Type field 246 (e.g., occupying five bits) are used for encoding or indicating that header 240 is a header of a VDM request micro-packet. As indicated at row 243, a micro-packet sequence ID field 247 (e.g., occupying five bits) and/or a micro-packet packet number field 248 (e.g., occupying five bits) are used, for example, thereby redefining or replacing a Length field. Row 249A is used for message routing information and device vendor identification; row 249B is reserved for vendor-specific use.

Reference is made to FIG. 2E, which schematically illustrate a structure of a continuation micro-packet header 250 in accordance with some demonstrative embodiments of the invention. Header 250 is header of a continuation micro-packet, namely, a header of a non-initial micro-packet in a stream. A first row 251 indicates the byte offset (for example, +0, +1, +2 and +3); and a second row 252 indicates the bit count (for example, eight bits numbered from 0 to 7). Header 250 includes fields of control information occupying four bytes, as indicated in row 253. The values in a Format (Fmt) field 255 (e.g., occupying two bits) and/or a Type field 256 (e.g., occupying five bits) are used for encoding or indicating that header 250 is a header of a continuation micro-packet. As indicated at row 253, a micro-packet sequence ID field 257 (e.g., occupying five bits) and/or a micro-packet packet number field 258 (e.g., occupying five bits) are used, for example, thereby redefining or replacing a Length field. In some embodiments, the size (e.g., in bytes) of header 250 of a continuation micro-packet is smaller, or significantly smaller, than the size of non-continuation headers 210, 220, 230 or 240.

Some embodiments provide a performance improvement (“boost”) which may depend on or may be a function of, for example, the payload size and/or on the size (e.g., in bytes) of micro-packets used. The following table, denoted Table 1, shows demonstrative performance improvement and transfer sizes in accordance with some embodiments of the invention:

TABLE 1

| | | | (D) | (E) | (F) | (G) |
|---|---|---|---|---|---|---|
| | (B) | | Transfer | Transfer | Transfer | Transfer |
| | Performance | (C) | Size using | Size using | Size using | Size using |
| (A) | Improvement | Base TLP | 512-Bytes | 1-KB | 2-KB | 4-KB |
| Payload Size | (“Boost”) | Transfer | micro- | micro- | micro- | micro- |
| (Bytes) | in Percents | Size | packets | packets | packets | packets |
| 16 | 10+ | 32.4 | 42.4 | 42.6 | 42.7 | 42.8 |
| 32 | 10+ | 49.0 | 59.2 | 59.6 | 59.8 | 59.9 |
| 64 | 8-9 | 65.8 | 73.7 | 74.3 | 74.7 | 74.8 |
| 128 | 5-6 | 79.3 | 84.0 | 84.9 | 85.3 | 85.5 |
| 256 | 2-3 | 88.5 | 90.4 | 91.3 | 91.8 | 92.1 |
| 512 | 1-2 | 93.9 | 93.9 | 94.9 | 95.5 | 95.7 |
| 1024 | <1 | 96.8 | NC | 96.8 | 97.4 | 97.7 |
| 2048 | <0.5 | 98.4 | NC | NC | 98.4 | 98.7 |
| 4096 | <0.5 | 99.2 | NC | NC | NC | 99.2 |

In Table 1, column (A) indicates the payload size in bytes; column B indicates the estimated performance improvement (“boost”) achieved using micro-packets; column (C) indicates the base TLP transfer size, namely, without using micro-packets; column (D) indicates the transfer size using 512-bytes micro-packets; column (E) indicates the transfer size using 1-kilobyte micro-packets; column (F) indicates the transfer size using 2-kilobyte micro-packets; and column (G) indicates the transfer size using 4-kilobyte micro-packets. Table cells denoted with “NC” indicate that their respective data was not calculated.

As demonstrated in Table 1, PCIe communication using packet fragmentation with a payload size of 16 bytes may result in a performance improvement of more than 10 percent; PCIe communication using packet fragmentation with a payload size of 32 bytes may result in a performance improvement of more than 10 percent; PCIe communication using packet fragmentation with a payload size of 64 bytes may result in a performance improvement of approximately 8 to 9 percent; PCIe communication using packet fragmentation with a payload size of 128 bytes may result in a performance improvement of approximately 5 to 6 percent; and PCIe communication using packet fragmentation with a payload size of 256 bytes may result in a performance improvement of approximately 2 to 3 percent. In some embodiments, each percent point improvement in link utilization may result in, for example, up to 160 MegaByte per Second (MB/s) for a PCIe version 2.0 link having a 16-time (×16) rate and signaling speed of 5 GigaTransfers per second (GT/s). The values of Table 1 are presented for demonstrative purposes only; other values, calculations or estimations may be used, and other benefits or advantages may be achieved using embodiments of the invention.

In some embodiments, PCIe packet fragmentation may be efficient, for example, in systems utilizing a relatively large MPS value. For example, link utilization may be improved and may require significantly smaller buffers, latency may be reduced, high-priority traffic may be better supported, or other benefits may be achieved. Some embodiments may be used, for example, in conjunction with Direct Memory Access (DMA) systems or devices.

In some embodiments, the reduced header format used by continuation micro-packets allows an improvement of link utilization by up to approximately 20 percent (e.g., achieving up to 90 percent of the theoretical bandwidth), for example, when using MPS of 4 kilobytes and a fragment size of 128 bytes. In some embodiments, such link utilization may be lower compared to the utilization achieved by using a 4 kilobytes MPS without packet fragmentation; but packet fragmentation may result in significant performance improvement compared to the performance using a 128 bytes MPS without packet fragmentation.

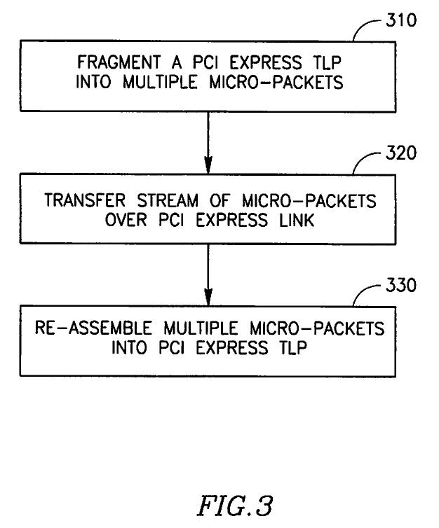

FIG. 3 is a schematic flow-chart of a method of PCIe packet fragmentation and re-assembly in accordance with some demonstrative embodiments of the invention. Operations of the method may be used, for example, by system 100 of FIG. 1, and/or by other suitable units, devices and/or systems.

In some embodiments, the method may include, for example, fragmenting a PCIe TLP (macro-packet) into multiple micro-packets (block 310). The method may further include, for example, transferring a stream of the micro-packets over a PCIe link (block 320). The method may further include, for example, re-assembling the received stream of micro-packets into a PCIe TLP (block 330), which may be substantially identical to the PCIe TLP that was fragmented.

Other suitable operations or sets of operations may be used in accordance with embodiments of the invention.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus for fragmentation of Peripheral Component Interconnect (PCI) express packets, said apparatus comprising:
a credit-based flow control interconnect device to fragment a Transaction Layer Packet into a stream of micro-packets, wherein the stream comprises an initial micro-packet and one or more continuation micro-packets.

2. The apparatus of claim 1, wherein the initial micro-packet comprises an initial header, wherein each continuation micro-packet comprises a continuation header, and wherein the size of the continuation header is smaller than the size of the initial header.

3. The apparatus of claim 2, wherein continuation headers of substantially all the continuation micro-packets have the same size.

4. The apparatus of claim 2, wherein the size of substantially each continuation header is not larger than one Double Word.

5. The apparatus of claim 2, wherein the initial header comprises an indication that one or more continuation micro-packets are expected to follow the initial micro-packet.

6. The apparatus of claim 5, wherein the indication in the initial header is encoded in at least one of:
a Format field of the initial header, and
a Type field of the initial header.

7. The apparatus of claim 2, wherein the initial header comprises an indication of the number of micro-packets in the stream.

8. The apparatus of claim 2, wherein substantially each continuation header comprises a micro-packet sequence identification number and a micro-packet packet number.

9. The apparatus of claim 1, further comprising:
another credit-based flow control interconnect device to receive the stream of micro-packets and to re-assemble the Transaction Layer Packet from the stream of micro-packets.

10. The apparatus of claim 1, wherein the credit-based flow control interconnect device comprises a PCI Express device.

11. A method for fragmentation of Peripheral Component Interconnect (PCI) express packets, said method comprising:
dividing a Transaction Layer Packet of a credit-based flow control interconnect protocol into a stream of fragments, wherein the stream comprises an initial fragment and one or more continuation fragments.

12. The method of claim 11, further comprising:
transferring the stream of fragments over a link layer of said credit-based flow control interconnect protocol.

13. The method of claim 12, further comprising:
receiving the stream of fragments; and
re-assembling the Transaction Layer Packet from the stream of fragments.

14. The method of claim 11, wherein the credit-based flow control interconnect protocol comprises PCI Express, the method comprising:
checking whether or not a PCI Express device supports PCI Express packet fragmentation; and
if the PCI Express device supports PCI Express packet fragmentation, transferring to said PCI Express device the stream of fragments.

15. The method of claim 11, wherein the credit-based flow control interconnect protocol comprises PCI Express, the method comprising:
checking whether or not a PCI Express device supports PCI Express packet fragmentation; and
if the PCI Express device does not support PCI Express packet fragmentation, transferring to said PCI Express said PCI Express Transaction Layer Packet.

16. The method of claim 11, wherein the credit-based flow control interconnect protocol comprises PCI Express, and wherein dividing a PCI Express Transaction Layer Packet into a stream of fragments comprises dividing a PCI Express request Transaction Layer Packet into a stream of fragments.

17. The method of claim 11, wherein the credit-based flow control interconnect protocol comprises PCI Express, and wherein dividing a PCI Express Transaction Layer Packet into a stream of fragments comprises dividing a PCI Express completion Transaction Layer Packet into a stream of fragments.

18. A system for fragmentation of Peripheral Component Interconnect (PCI) express packets, said system comprising:
a credit-based flow control interconnect device to fragment a credit-based flow control interconnect Transaction Layer Packet into a stream of micro-packets, wherein the stream comprises an initial micro-packet and one or more continuation micro-packets; and
a credit-based flow control interconnect link layer to transfer the stream of micro-packets.

19. The system of claim 18, further comprising:
at least one additional credit-based flow control interconnect device to receive the stream of micro-packets and to re-assemble the Transaction Layer Packet from the stream of micro-packets.

20. The system of claim 18, wherein the credit-based flow control interconnect device comprises a PCI Express device, wherein the initial micro-packet comprises an initial header, wherein each continuation micro-packet comprises a continuation header, and wherein the size of the continuation header is smaller than the size of the initial header.
